(19) United States
(12) Patent Application Publication
(10) Pub. No.: US 2019/0216253 A1
(43) Pub. Date: Jul. 18, 2019

(54) Coffee Pot Decoupling Device

(71) Applicant: Magnus Rosa, New Cumberland, PA (US)

(72) Inventor: Magnus Rosa, New Cumberland, PA (US)

(21) Appl. No.: 15/873,702

(22) Filed: Jan. 17, 2018

(51) Int. Cl. A47J 31/44; A47J 31/30

(52) U.S. Cl. CPC A47J 31/44; A47J 31/303

(57) ABSTRACT

A coffee pot decoupling device for a two-chambered coffee pot includes a plate. A coupler that is coupled to the plate is configured to couple the plate to a surface to prevent rotation of the plate relative to the surface. An orifice is centrally positioned through the plate. The orifice is substantially complementary to a base of a lower chamber of a two-chambered pot. The orifice is configured to insert the base of the lower chamber to fixedly position the lower chamber relative to the surface. A user is positioned to rotate an upper chamber of the two-chambered pot relative to the lower chamber to decouple the upper chamber from the lower chamber.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to decoupling devices and more particularly pertains to a new decoupling device for a two-chambered coffee pot.

### BRIEF SUMMARY OF THE INVENTION

An embodiment of the disclosure meets the needs presented above by generally comprising a plate. A coupler that is coupled to the plate is configured to couple the plate to a surface to prevent rotation of the plate relative to the surface. An orifice is centrally positioned through the plate. The orifice is substantially complementary to a base of a lower chamber of a two-chambered pot. The orifice is configured to insert the base of the lower chamber to fixedly position the lower chamber relative to the surface. A user is positioned to rotate an upper chamber of the two-chambered pot relative to the lower chamber to decouple the upper chamber from the lower chamber.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a coffee pot decoupling device according to an embodiment of the disclosure.

FIG. 2 is a side view of an embodiment of the disclosure.

FIG. 3 is a bottom view of an embodiment of the disclosure.

FIG. 4 is a front view of an embodiment of the disclosure.

FIG. 5 is an in-use view of an embodiment of the disclosure.

### DETAILED DESCRIPTION OF THE INVENTION

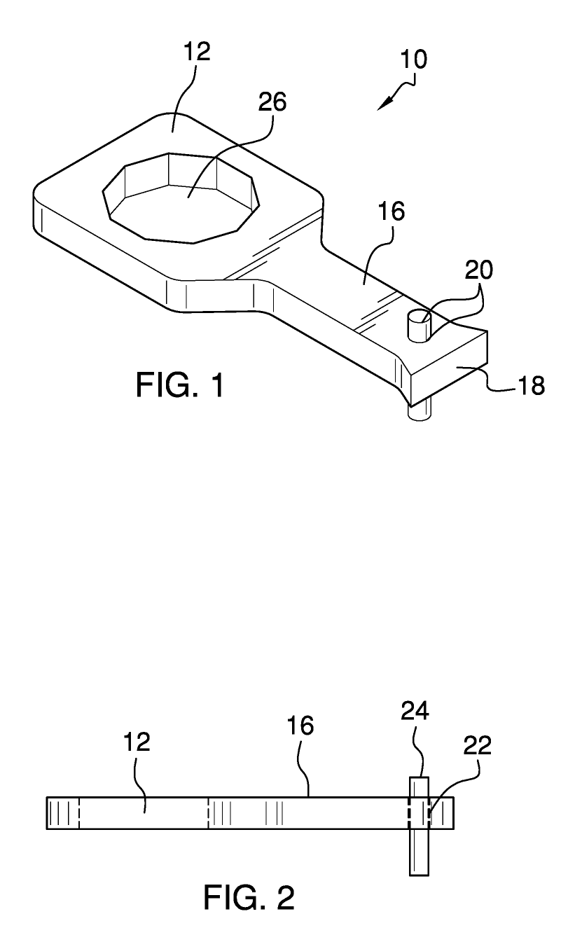

With reference now to the drawings, and in particular to FIGS. 1 through 5 thereof, a new decoupling device embodying the principles and concepts of an embodiment of the disclosure and generally designated by the reference numeral 10 will be described.

As best illustrated in FIGS. 1 through 5, the coffee pot decoupling device 10 generally comprises a plate 12. The plate 12 is substantially rectangularly shaped and defines corners 14 of the plate 12. The corners 14 are rounded, as shown in FIG. 1.

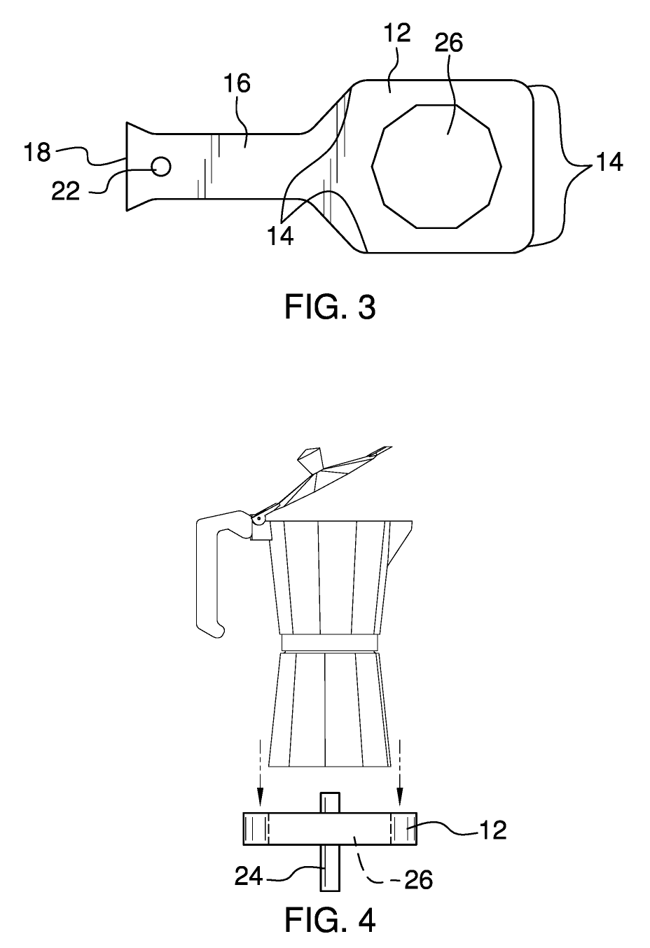

A handle 16 is coupled to and extends coplanarly from the plate 12. The handle 16 has a terminus 18 distal from the plate 12. The terminus 18 is flared, as shown in FIG. 3.

A coupler 20 is coupled to the plate 12. The coupler 20 is configured to couple the plate 12 to a surface, such as a countertop, to prevent rotation of the plate 12 relative to the surface.

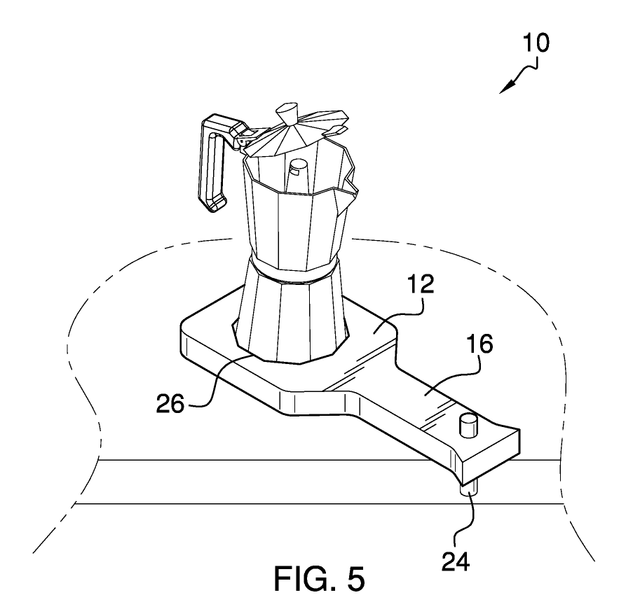

The coupler 20 comprises a hole 22 and a dowel 24. The hole 22 is positioned through the handle 16 distal from the plate 12. The dowel 24 is complementary to and selectively insertable into the hole 22. The hole 22 is positioned to selectively insert the dowel 24 so that the dowel 24 is configured to position in abutment to an edge of the surface, as shown in FIG. 5, to prevent rotation of the plate 12 relative to the surface. The dowel 24 is circularly shaped when viewed longitudinally.

An orifice 26 is centrally positioned through the plate 12. The orifice 26 is substantially complementary to a base of a lower chamber of a two-chambered pot, such as a Cuban-style coffee pot and an Italian-style espresso pot. The orifice 26 is octagonally shaped, as shown in FIG. 3. The orifice 26 is configured to insert the base of the lower chamber, as shown in FIG. 4, to fixedly position the lower chamber relative to the surface. A user is positioned to rotate an upper chamber of the two-chambered pot relative to the lower chamber to decouple the upper chamber from the lower chamber.

In use, the hole 22 that is positioned in the handle 16 is positioned to selectively insert the dowel 24. The dowel 24 is configured to position in abutment to the edge of the surface to prevent rotation of the plate 12 relative to the surface. The orifice 26 is configured to insert the base of the lower chamber to fixedly position the lower chamber relative to the surface. The user is positioned to rotate the upper chamber relative to the lower chamber to decouple the upper chamber from the lower chamber.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A coffee pot decoupling device comprising:
a plate;
a coupler coupled to said plate, said coupler being configured for coupling said plate to a surface;
an orifice centrally positioned through said plate, said orifice being substantially complementary to a base of a lower chamber of a two-chambered pot; and
wherein said coupler is positioned on said plate such that said coupler is configured for coupling said plate to the surface for preventing rotation of said plate relative to the surface, wherein said orifice is positioned in said plate such that said orifice is configured for inserting the base of the lower chamber for fixedly positioning the lower chamber relative to the surface positioning a user for rotating an upper chamber of the two-chambered pot relative to the lower chamber for decoupling the upper chamber from the lower chamber.

2. The device of claim 1, further including said plate being substantially rectangularly shaped defining corners of said plate.

3. The device of claim 2, further including said corners being rounded.

4. The device of claim 1, further including a handle coupled to and extending coplanarly from said plate.

5. The device of claim 4, further including said handle having a terminus distal from said plate, said terminus being flared.

6. The device of claim 4, further including said coupler comprising:
a hole and, said hole being positioned through said handle distal from said plate;
a dowel complementary to and selectively insertable into said hole, wherein said hole is positioned in said handle such that said hole is positioned for selectively inserting said dowel such that said dowel is configured for positioning in abutment to an edge of the surface for preventing rotation of said plate relative to the surface.

7. The device of claim 6, further including said dowel being circularly shaped when viewed longitudinally.

8. The device of claim 1, further including said orifice being octagonally shaped.

9. A coffee pot decoupling device comprising:
a plate, said plate being substantially rectangularly shaped defining corners of said plate, said corners being rounded;
a handle coupled to and extending coplanarly from said plate, said handle having a terminus distal from said plate, said terminus being flared;
a coupler coupled to said plate, said coupler being configured for coupling said plate to a surface, wherein said coupler is positioned on said plate such that said coupler is configured for coupling said plate to the surface for preventing rotation of said plate relative to the surface, said coupler comprising a hole and a dowel, said hole being positioned through said handle distal from said plate, said dowel being complementary to and selectively insertable into said hole, wherein said hole is positioned in said handle such that said hole is positioned for selectively inserting said dowel such that said dowel is configured for positioning in abutment to an edge of the surface for preventing rotation of said plate relative to the surface, said dowel being circularly shaped when viewed longitudinally;
an orifice centrally positioned through said plate, said orifice being substantially complementary to a base of a lower chamber of a two-chambered pot, wherein said orifice is positioned in said plate such that said orifice is configured for inserting the base of the lower chamber for fixedly positioning the lower chamber relative to the surface positioning a user for rotating an upper chamber of the two-chambered pot relative to the lower chamber for decoupling the upper chamber from the lower chamber, said orifice being octagonally shaped; and
wherein said hole is positioned in said handle such that said hole is positioned for selectively inserting said dowel such that said dowel is configured for positioning in abutment to the edge of the surface for preventing rotation of said plate relative to the surface, wherein said orifice is positioned in said plate such that said orifice is configured for inserting the base of the lower chamber for fixedly positioning the lower chamber relative to the surface positioning the user for rotating the upper chamber relative to the lower chamber for decoupling the upper chamber from the lower chamber.
